(19) United States
(12) Patent Application Publication
(10) Pub. No.: US 2018/0009473 A1
(43) Pub. Date: Jan. 11, 2018

(54) STEERING CONTROL DEVICE

(71) Applicant: DENSO CORPORATION, Kariya-city (JP)

(72) Inventors: Hisaya AKATSUKA, Kariya-city (JP); Daiji WATANABE, Kariya-city (JP)

(21) Appl. No.: 15/644,348

(22) Filed: Jul. 7, 2017

(30) Foreign Application Priority Data
Jul. 11, 2016 (JP) 2016-136949

(51) Int. Cl. B62D 6/00; B62D 5/04

(52) U.S. Cl. CPC B62D 6/002; B62D 5/0463

(57) ABSTRACT

In a drive assist system, a map data acquiring section acquires a forward road shape and a rearward road shape. The forward road shape represents a road shape at a forward position in front of a current position of an own vehicle on a road on which the own vehicle drives. The rearward road shape represents a road shape at a rearward position on the road. The rearward position is behind the forward position and in front of the current position of the own vehicle on the road. An assist control calculation section determines steering characteristics of the own vehicle at the target position located between the forward position and the rearward position based on the forward road shape and the rearward road shape, and adjusts a steering angle of the own vehicle on the basis of the determined steering characteristics of the own vehicle.

### CROSS-REFERENCE TO RELATED APPLICATION

This application is related to and claims priority from Japanese Patent Application No. 2016-136949 filed on Jul. 11, 2016, the contents of which are hereby incorporated by reference.

### BACKGROUND OF THE INVENTION

### 1. Field of the Invention

The present invention relates to steering control devices capable of executing steering control of an own vehicle.

### 2. Description of the Related Art

Patent document 1, Japanese patent laid open publication No. 2015-093569, has disclosed a steering control device having a structure capable of executing steering control of a vehicle on the basis of feedback control.

However, conventional feedback control executed by the steering control device disclosed by the Patent document 1 previously described has a drawback of causing a delay of the steering control at a target position of the vehicle because the steering control at the target position of the vehicle is executed on the basis of output values transmitted from sensors obtained at a past timing at the current position before the target position of the vehicle.

### SUMMARY

It is therefore desired to provide a steering control device capable of suppressing a delay of steering control at a target position of an own vehicle.

An exemplary embodiment provides a steering control device which executes steering control of an own vehicle. The steering control device has a computer system including a central processing unit. The computer system is configured to provide a road shape information acquiring section, a characteristics determination section, and a steering angle control section. The road shape information acquiring section acquires a forward road shape and a rearward road shape. The forward road shape represents a road shape at a forward position (as a first position) in front of a current position of an own vehicle on a road on which the own vehicle drives. The rearward road shape represents a road shape at a rearward position (as a second position) on the road. In particular, the rearward position is behind the forward position and is in front of the current position of the own vehicle on the road. The

characteristics determination section determines steering characteristics of the own vehicle at a target position on the road on the basis of the forward road shape and the rearward road shape acquired by the road shape information acquiring section. The target position is located between the forward position and the rearward position on the road. The steering angle control section controls the steering angle of the own vehicle on the basis of the steering characteristics of the own vehicle determined by the characteristics determination section.

Because the steering control device having the structure previously described determines the steering characteristics of the own vehicle on the basis of the acquired forward road shape and the rearward road shape, this structure makes it possible to speedily suppress generation of a control delay of the steering angle of the own vehicle with high efficiency.

### BRIEF DESCRIPTION OF THE DRAWINGS

A preferred, non-limiting embodiment of the present invention will be described by way of example with reference to the accompanying drawings, in which:

FIG. 1 is a block diagram showing a structure of a drive assist system as a steering control device to be mounted on an own vehicle according to an exemplary embodiment of the present invention;

FIG. 2 is a view showing functional blocks of a control section 10 in the drive assist system 1 as the steering control device according to the exemplary embodiment of the present invention;

FIG. 3 is a view showing a block diagram showing functions of an assist control calculation section 50 in the control section 10 in the drive assist system 1;

FIG. 4 is a flow chart showing an assist control process executed by the control section in the drive assist system according to the exemplary embodiment of the present invention;

FIG. 5 is a flow chart showing a steering angle increase state detection process executed by the control section in the drive assist system according to the exemplary embodiment of the present invention;

FIG. 6 is a flow chart showing a steering angle return state detection process executed by the control section in the drive assist system according to the exemplary embodiment of the present invention;

FIG. 7 is a flow chart showing a steering timing judgment process executed by the control section in the drive assist system according to the exemplary embodiment of the present invention;

FIG. 8 is a view showing an example of various control parameters, to be determined in the steering timing judgment process shown in FIG. 7 executed by the control section in the drive assist system;

FIG. 9 is a flow chart showing a steering angle calculation process executed by the control section in the drive assist system;

FIG. 10 is a plan view showing a schematic explanation of a minute time Δt (a phase delay time Δt) used by the steering angle calculation process executed by the control section in the drive assist system;

FIG. 11 is a block diagram showing a transfer function of the control device which calculates a yaw rate γ on the basis of the steering angle δ;

FIG. 12 is a view showing Bode plots which represent frequency characteristics of the transfer function;

FIG. 13 is a graph representing comparison results in phase delay between a backward differential method and a central differential method; and

FIG. 14 is a view showing functional blocks of a control section having another structure in the drive assist system according to a modification of the exemplary embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### Exemplary Embodiment

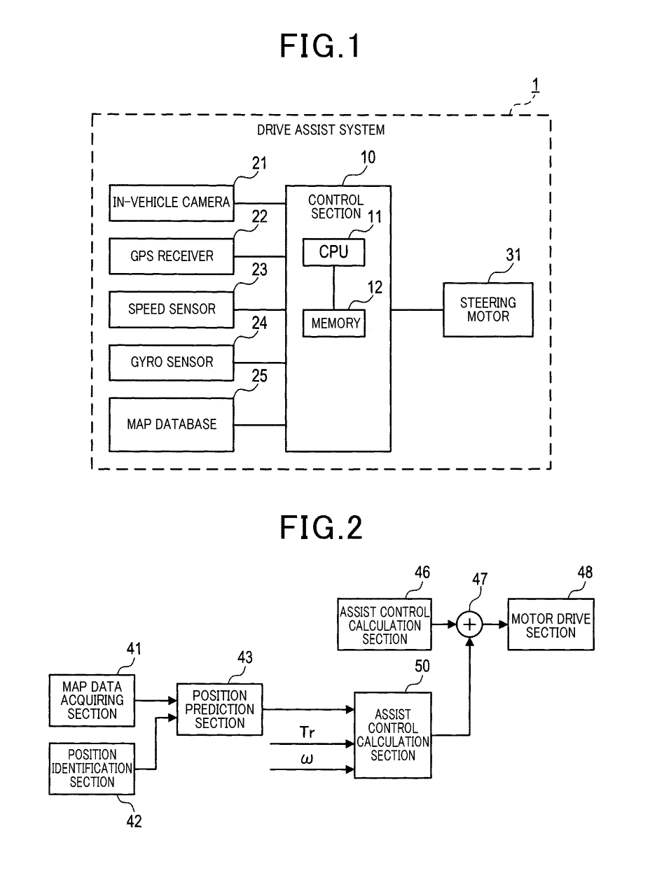

A description will be given of a drive assist system 1 as a steering control device to be mounted on an own vehicle with reference to FIG. 1 to FIG. 14.

### (Structure)

FIG. 1 is a block diagram showing a structure of the drive assist system 1 as the steering control device according to an exemplary embodiment.

The drive assist system 1 is mounted on the own vehicle such as a passenger vehicle, etc., and provides driving assistance to the driver of the own vehicle. In particular, the drive assist system 1 according to the exemplary embodiment provides an assist control of the steering wheel of the own vehicle on which the drive assist system 1 is mounted.

The drive assist system 1 shown in FIG. 1 has a control section 10. The drive assist system 1 has an in-vehicle camera 21, a GPS (Global Positioning System) receiver, a speed sensor 23, a gyro sensor 24, a map database 25, a steering motor 31, etc. The GPS represents a space-based radio-navigation system.

The in-vehicle camera 21 captures a forward view of the own vehicle and transmits a captured image to the control section 10. The GPS receiver 22 is a well-known device which receives radio waves transmitted from GPS satellites, and detects a current position or current location of the own vehicle on a road on the basis of the received radio waves.

The speed sensor 23 is a well-known sensor which detects a current speed of the own vehicle. The gyro sensor is a well-known device which detects a rotary angular speed of the own vehicle. The map database 25 stores known map information in which latitude and longitude on the earth correspond to road data. For example, the road data show a relationship between the position or location of a road, road shape information (which will be explained later), etc.

In order to specify the direction of the road on which the own vehicle drives, it is sufficient to use the road data including directional information which represents which direction the road is linked. That is, it is sufficient for the road data to show a curvature ρ of a road and a degree of a slope at every position on the road. The exemplary embodiment uses the road data which include a curvature p at a selected position on a road, and a degree of a slope at the selected position on the road.

The steering motor 31 provides a rotation power, i.e. a torque to a mechanical assembly of a known power steering control device so as to change a steering angle. That is, the control section 10 instructs the steering motor 31 to provide a torque to the mechanical assembly in the power steering control device. This means that the control section 10 executes the drive assist.

The control section 10 is composed of a known microcomputer which has a central processing unit 11 (CPU 11), a semiconductor memory (hereinafter, the memory 12) such as a random access memory (RAM), a read only memory (ROM), a flash memory, etc. The control section 10 executes programs stored in a non-transitory computer readable storage medium as the semiconductor memory 12.

The execution of the programs stored in the memory 12 provides the method according to the exemplary embodiment of the present invention which will be explained in detail later. It is acceptable for the control section 10 to have one or more microcomputers.

FIG. 2 is a view showing functional blocks of a control section 10 in the drive assist system 1 as the steering control device according to the exemplary embodiment.

As shown in FIG. 2, the control section 10 has plural functional blocks, i.e. a map data acquiring section 41, a position identification section 42, a position prediction section 43, an assist control calculation section 46, an addition section 47, a motor drive section 48, and an assist control calculation section 50. That is, when executing the programs stored in the memory 12, the control section 10 provides the functions of those sections such as the map data acquiring section 41, the position identification section 42, the position prediction section 43, the assist control calculation section 46, the addition section 47, the motor drive section 48, and the assist control calculation section 50.

It is also acceptable to use one or more hardware devices so as to realize one or more functions of those sections 41 to 43, 46 to 48 and 50. For example, when a function is realized by using a hardware device, it is acceptable to use a digital circuit, an analogue circuit, or a combination of a digital circuit and an analogue circuit composed of plural logic circuits.

The map data acquiring section 41 in the control section 10 of the drive assist system 1 according to the exemplary embodiment acquires road shape information from the map database 25. The road shape information is used for determining the direction of the road on which the own vehicle drives. The road shape information represents information to be used for obtaining the direction of the road. For example, the road shape information includes a curvature p of the road, a degree of a slope of the road, etc. on which the own vehicle drives.

The road shape information further includes a rear side position of the road at which the own vehicle has passed, the current position of the own vehicle on the road, and a forward position (as a first position) in front of the current position of the own vehicle on the road.

That is, the map data acquiring section 41 has the function which acquires road shape information of the road within a predetermined range which includes a future position of the own vehicle on which the own vehicle may drive on the basis of the detected current position of the own vehicle.

It is acceptable that the road shape information obtained by the map data acquiring section 41 corresponds to the road shape information which has been stored in the map database 25. It is also acceptable to obtain the road shape information on the basis of the information stored in the map database 25. Specifically, when the map database 25 has stored information regarding the curvature p of the road and the degree of the slope of the road on which the own vehicle drives, it is sufficient for the map data acquiring section 41 to acquire the information regarding the curvature p of the road and the degree of the slope of the road from the map database 25. On the other hand, if the map database 25 does not store any information regarding the curvature p of the road and the degree of the slope of the road, it is sufficient for the map data acquiring section 41 to generate the information regarding the curvature p of the road and the degree of the slope of the road on the basis of coordinate information of a node and a link and use, as the road shape information, the generated information regarding the curvature p of the road and the degree of the slope of the road on which the own vehicle drives.

The control section 10 determines the direction of the road, on which the own vehicle drives, on the basis of the acquired road shape information. That is, the control section 10 recognizes which direction the road extends on the basis of the road shape information, and determines a steering angle of the own vehicle. The control section 10 determines the steering angle of the own vehicle so as for the own vehicle to drive along the direction of the road on the basis of the road shape information.

In particular, the map data acquiring section 41 obtains a forward road shape at a forward position X (N+Δt) in front of a target position X (N) on the road on which the own vehicle drives, and further obtains a rearward road shape at a rearward position X (N−Δt) of the target position X (N) on the road, where the target position X (N) is a position on the road which the own vehicle will pass at a predetermined future time, i.e. N seconds later. In particular, the rearward position is behind the forward position and the target position, and is in front of the current position of the own vehicle on the road.

This calculation of the map data acquiring section 41 will be explained in detail later. The obtained forward road shape previously described corresponds to a road shape at a forward position at a phase delay time Δt caused by differential calculation of the target position X(N).

The position identification section 42 in the control section 10 of the drive assist system 1 according to the exemplary embodiment obtains the drive direction of the own vehicle and a speed of the own vehicle on the basis of the information transmitted from the GPS receiver 22 and the gyro sensor 24. The position identification section 42 further executes a matching process, i.e. an identification process so as to match the map data obtained from the map database 25 with the current position of the own vehicle.

The position prediction section 43 in the control section 10 of the drive assist system 1 according to the exemplary embodiment continuously predicts various positions in front of the current position of the own vehicle on the road, and further estimates the direction of the road on which the own vehicle drives according to the road shape information on the basis of the results of the identification process of the position of the own vehicle, the driving direction and driving speed of the own vehicle.

In particular, the position prediction section 43 in the control section 10 of the drive assist system 1 according to the exemplary embodiment calculates a curvature p of each of plural positions of the own vehicle in the near future on the road so as to specify the curvature ρ at the forward position, the curvature p at the rearward position X (N−Δt) of the own vehicle on the road even if the parameters N and Δt are varied by the process which will be described later. The greater the curvature ρ of the road is, the smaller the radius of the curvature ρ is, and the more sharply curved the road is.

Similarly, the position prediction section 43 obtains, i.e. calculates a degree of a slope at the position of the road through which the own vehicle would pass N seconds later. The position prediction section 43 transmits the curvature p of the road, the degree of the slope of the road and the steering timing to the assist control calculation section 50.

The assist control calculation section 46 calculates an assist control amount to be used by the steering control process. For example, like a known method and structure, the assist control calculation section 46 multiplies a steering torque Tr and a predetermined gain together so as to obtain the assist control amount.

The addition section 47 adds the control amount calculated by the assist control calculation section 50 and the assist control amount calculated by the assist control calculation section 46.

When receiving the output value as the addition result of the addition section 47, the motor drive section 48 drives the steering motor 31 on the basis of the output from the addition section 47.

The assist control calculation section 50 determines control parameters which represents a degree of steering operation to the steering wheel of the own vehicle according to the direction of the road so that the direction of the road matches with the drive direction of the own vehicle. The drive assist system 1 according to the exemplary embodiment uses, as the drive direction of the own vehicle, the direction of the road obtained on the basis of the curvature p of the road at the current position of the own vehicle on the road.

The control parameters represent one or more control values which affect the steering control amount obtained by the assist control calculation section 50. For example, the control parameters include a resistance degree of the steering operation using the steering wheel, a steering stability of the steering operation, a turning ability of the own vehicle, steering set values, and in particular, a mechanical impedance of the steering mechanism. The steering mechanism transmits the power to the vehicle wheels of the own vehicle. The assist control calculation section 50 calculates those control parameters by using the steering torque Tr and a steering speed ω.

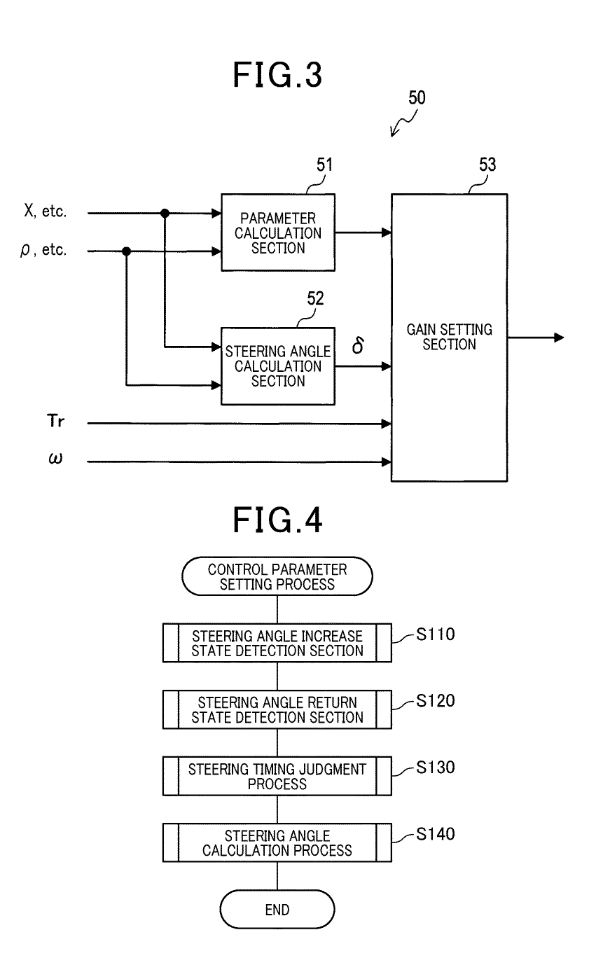

FIG. 3 is a view showing a block diagram showing functions of the assist control calculation section 50 in the control section 10 in the drive assist system 1.

In more detail, as shown in FIG. 3, the assist control calculation section 50 has a parameter calculation section 51, a steering angle calculation section 52 and a gain setting section 53. The parameter calculation section 51 executes the assist control process, which will be explained later, and outputs a control amount which corresponds to a curvature p of the road and a degree of the slope of the road.

The parameter calculation section 51 detects whether the steering wheel of the own vehicle is in a steering angle increase state or a steering angle return state. The steering angle increase state represents the increase state of the current steering wheel angle of the own vehicle. On the other hand, the steering angle return state represents the steering angle of the steering wheel of the own vehicle is reduced. For example, in the steering angle return state, the steering angle of the steering wheel is changed toward a steering angle which curves the own vehicle to drive forward without the vehicle turning.

The parameter calculation section 51 determines steering characteristics of the own vehicle on the basis of the detection result.

The steering characteristics of the own vehicle represent characteristics regarding the steering operation. For example, the steering characteristics contain a steering angle, response characteristics, etc. The parameter calculation section 51 determines, as the response characteristics, at least one of yaw response, roll response, and lateral G.

The steering angle calculation section 52 calculates a target steering angle at the target position of the vehicle on the road. The gain setting section 53 executes various calculations by using a steering torque Tr, a steering speed ω, and a gain as the steering characteristics determined by the parameter calculation section 51 so as to generate a control amount. The gain setting section 53 outputs the generated control amount in order for the own vehicle to have the target steering angle at the target position.

### (Process)

A description will be given of the assist control process executed by the control section 10 with reference to FIG. 4.

The drive assist system 1 starts to execute the assist control process when the power source supplies electric power to the drive assist system 1. The drive assist system 1 repeatedly executes the assist control process to calculate and output a control amount so as to control the steering angle of the steering wheel of the own vehicle.

FIG. 4 is a flow chart showing the assist control process executed by the control section 10 in the drive assist system according to the exemplary embodiment.

In step S110 shown in FIG. 4, the control section 10 executes a steering angle increase state detection process. The steering angle increase state detection process detects whether the steering state of the steering wheel of the own vehicle is in the steering angle increase state. In the steering angle increase state, the driver of the own vehicle increases the steering angle of the steering wheel from the steering angle when the own vehicle drives straight forward.

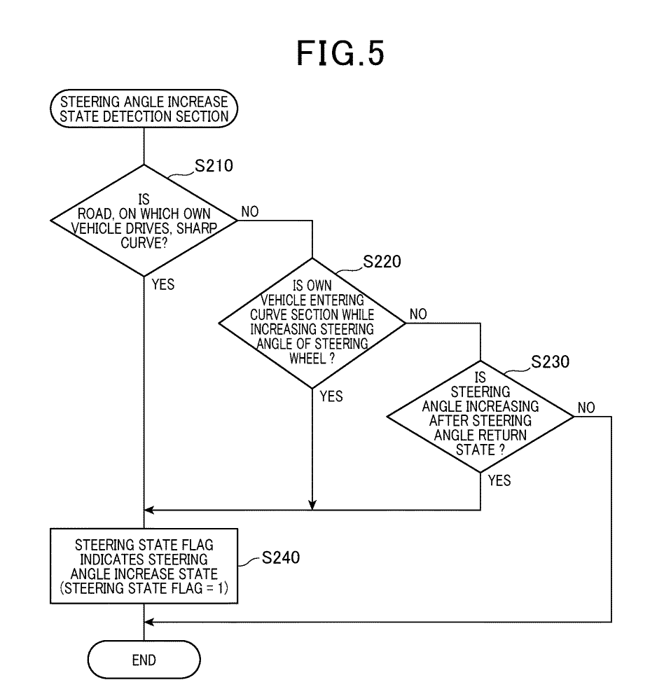

FIG. 5 is a flow chart showing the steering angle increase state detection process executed by the control section 10 in the drive assist system 1 according to the exemplary embodiment.

In step S210 shown in FIG. 5, in the steering angle increase state detection process, the control section 10 detects whether the road, on which own vehicle drives, is a sharp curve road. The control section 10 detects that the road is a sharp curve road when an absolute value of the curvature of a forward position on the road, through which the own vehicle would pass N seconds later, is less than a predetermined reference curvature ρ, and the curvature ρ of the current position on the road which has been previously detected is not less than a first reference curvature ρ. In this steering angle increase state detection process, in particular, the control section 10 detects whether the current position of the own vehicle on the road is changed from a straight section or a relatively loose curve section to a sharp curve section on the road.

When the detection result indicates affirmation (“YES” in step S210), i.e. indicates that the road is a sharp curve section, the operation flow progresses to step S240.

On the other hand, when the detection result indicates negation (“NO” in step S210), i.e. indicates that the road is not a sharp curve road, the operation flow progresses to step S220.

In step S220, the control section 10 detects whether the own vehicle is entering a curve section on the road while increasing the steering angle of the steering wheel of the own vehicle.

In step S220, the control section 10 detects that the own vehicle is entering a curve section on the road while increasing the steering of the steering wheel when the absolute value of the curvature p of the forward position on the road, through which the own vehicle would pass N seconds later, is less than a second reference curvature p, and a change direction of the curvature p of the road matches the curve direction of the road.

The control section 10 determines the first reference curvature which is not more than the second reference curvature.

When the own vehicle is entering a curve section on the road while increasing the steering angle of the steering wheel, the operation flow progresses to step S240.

On the other hand, when the own vehicle does not enter any curve section on the road without increasing the steering angle of the steering wheel, the operation flow progresses to step S230.

In step S230, the control section 10 detects whether the steering angle of the steering wheel increases, i.e. the steering angle increase state occurs after a steering angle return state of the steering wheel of the own vehicle.

In step S230, the control section 10 detects a curvature ρ of the road on which the own vehicle drives, and detects that the steering angle increase state occurs after a steering angle return state of the steering wheel of the own vehicle when the detected curvature ρ of the road is changed from a positive curvature to a negative curvature or a negative curvature to a positive curvature, and when a right curve section is changed to a left curve section on the road, or a left curve section is changed to a right curve section on the road. For example, a left curve section has a positive curvature and a right curve section has a negative curvature.

When the detection result in step S230 indicates affirmation (“YES” in step S230), i.e. indicates that the steering angle increase state occurs after the steering angle return state, the operation flow progresses to step S240.

In step S240, the control section 10 sets a value of 1 to a steering state flag (Steering state flag=1). The steering state flag has a value of 1 or 0 which represents a steering state of the steering wheel. When the steering state flag has the value of 1, the steering wheel is in the steering angle increase state. On the other hand, when the steering state flag has the value of 0, the steering wheel is in the steering angle return state.

When the detection result in step S230 indicates negation (“NO” in step S230), i.e. indicates that the steering angle increase state is not occurring after the steering angle return state, the control section 10 finishes the steering angle increase detection process shown in FIG. 5.

Next, the operation flow progresses to step S120 in the assist control process shown in FIG. 4. In step S120, the control section 10 executes the steering angle return state detection process. That is, the control section 10 detects whether the steering angle return state of the steering wheel occurs.

The steering angle return state of the steering wheel of the own vehicle represents the steering angle of the steering wheel is changed to a steering angle when the own vehicle is driving straight forward. In more detail, the control section 10 detects whether the steering angle of the steering wheel returns to zero, i.e. to the steering angle when the own vehicle moves straight forward.

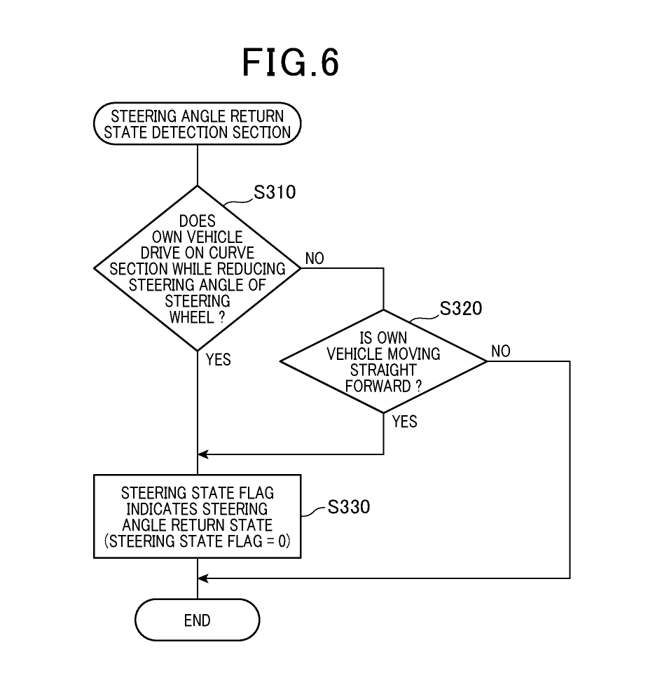

FIG. 6 is a flow chart showing the steering angle return state detection process executed by the control section 10 in the drive assist system 1 according to the exemplary embodiment.

In step S310 shown in FIG. 6, the control section 10 detects whether the own vehicle drives on a curve section on the road and the steering angle of the steering wheel reduces. For example, the control section 10 detects that the own vehicle drives on a curve section on the road while reducing the steering angle of the steering wheel when an absolute value of a curvature ρ of a forward position on the road, through which the own vehicle would pass N seconds later, is less than the predetermined reference curvature and a change direction of the curvature ρ of the road matches with a curve direction of the road.

In this process, it is acceptable for the control section 10 to use the first reference curvature or the second reference curvature as the predetermined reference curvature.

When the detection result indicates affirmation (“YES” in step S310), i.e. indicates that the own vehicle drives on a curve section on the road and the steering angle of the steering wheel reduces, the operation flow progresses to step S330.

On the other hand, when the detection result indicates negation (“NO” in step S310), i.e. indicates that the own vehicle is not driving through a curve se and the steering angle is constant, the operation flow progresses to step S320.

In step S320, the control section 10 detects that the own vehicle drives straight forward. For example, in step S320, the control section 10 detects that the own vehicle moves straight forward when an absolute value of a change amount of the curvature p of the road is less than a predetermined change regulation value.

When the detection result in step S320 indicates affirmation (“YES” in step S320), i.e. indicates that the own vehicle is driving straight forward, the operation flow progresses to step S330.

In step S330, the control section 10 sets a value of 0 to a steering state flag (Steering state flag=0).

As previously described, the steering state flag has the value of 1 or 0 which represents the steering state of the steering wheel. When the steering state flag has the value of 0, the steering wheel is in the steering angle return state.

When the detection result in step S320 indicates negation (“NO” in step S230), i.e. indicates that the own vehicle does not move straight forward, the control section 10 finishes the steering angle return detection process shown in FIG. 6.

Next, the operation flow progresses to step S130 in the assist control process shown in FIG. 4. In step S130, the control section 10 executes a steering timing judgment process. In the steering timing judgment process, the control section 10 adjusts various control parameters which correspond to the state of the own vehicle, i.e. which correspond to either the steering angle increase state or the steering angle return state of the steering wheel of the own vehicle.

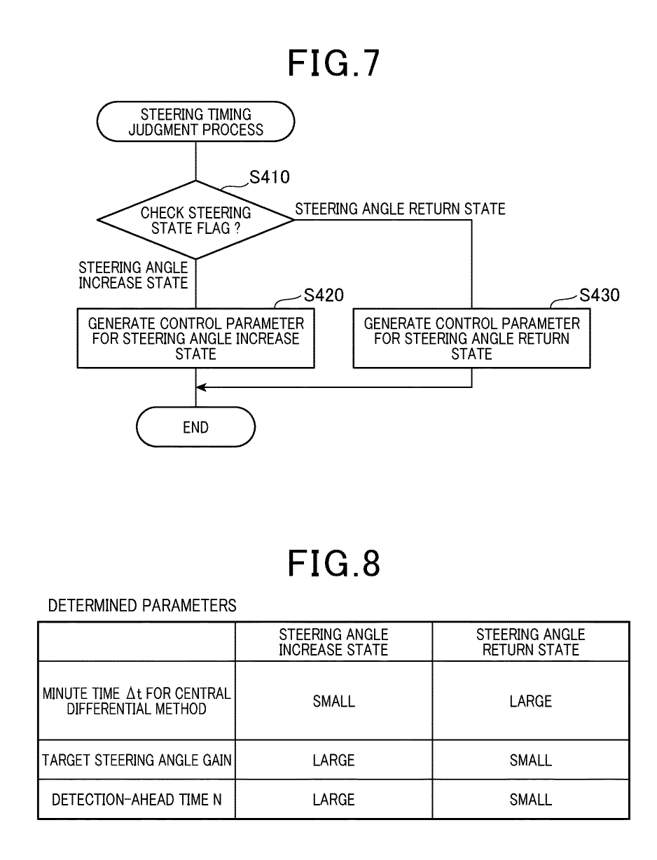

FIG. 7 is a flow chart showing the steering timing judgment process executed by the control section 10 in the drive assist system according to the exemplary embodiment.

In step S410 in the steering timing judgment process shown in FIG. 7, the control section 10 detects a value of the steering state flag.

When the detection result in step S410 indicates the steering angle increase state (the steering state flag=1), the operation flow progresses to step S420.

In step S420, the control section 10 generates the control parameter for the steering angle increase state. The control section 10 finishes the steering timing judgment process shown in FIG. 7.

On the other hand, when the detection result in step S410 indicates the steering angle return state (the steering state flag=0), the operation flow progresses to step S430.

In step S430, the control section 10 generates the control parameters to be used for the steering angle return state. The control section 10 finishes the steering timing judgment process shown in FIG. 7.

FIG. 8 is a view showing an example of various control parameters, to be determined in the steering timing judgment process shown in FIG. 7 executed by the control section 10 in the drive assist system.

In step S420 and step S430 shown in FIG. 7, the control section 10 adjusts the minute time Δt (or the phase delay time Δt) to be used by the central differential method (which will be explained later) so that the minute time Δt used in the steering angle increase state becomes smaller than the minute time Δt, i.e. the phase delay time Δt used in the steering angle return state, as shown in FIG. 8.

Further, as shown in FIG. 8, the control section 10 adjusts a target steering angle gain and a detection-ahead time N so that the target steering angle gain and a time N in the steering angle increase state become greater than the target steering angle gain and detection-ahead time N in the steering angle return state, as shown in FIG. 8.

As previously described, in the steering angle increase state and the steering angle return state, the control section 10 generates different steering characteristics, i.e. yaw response, roll response, and lateral G of the own vehicle.

That is, the parameter calculation section 51 and the steering angle calculation section 52 in the control section 10 determine the steering characteristics at an optional steering angle of the own vehicle so that the steering resistance in the steering angle increase state becomes smaller than the steering resistance in the steering angle return state.

In step S140 shown in FIG. 4, the control section 10 executes a steering angle calculation process for adjusting the steering angle of the own vehicle so as to allow the own vehicle to have the target steering angle at the target position on the road.

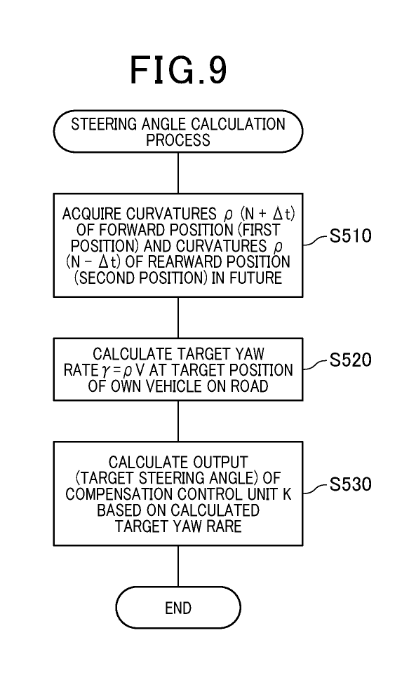

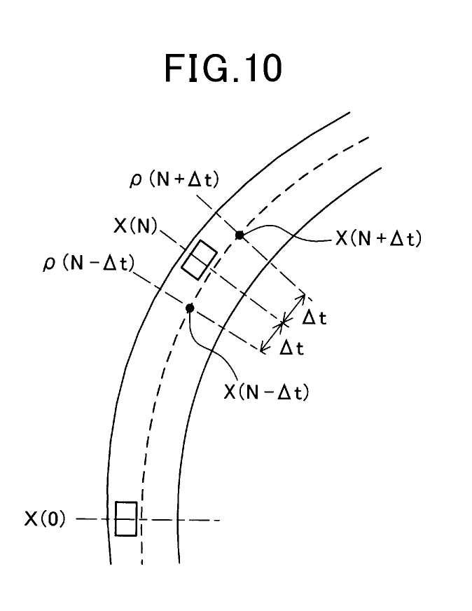

FIG. 9 is a flow chart showing the steering angle calculation process executed by the control section 10 in the drive assist system. FIG. 10 is a plan view showing a schematic explanation of the minute time Δt (i.e. the phase delay time Δt) used by the steering angle calculation process executed by the control section 10 in the drive assist system 1.

The control section 10 executes the process in step S510 shown in FIG. 9. As shown in FIG. 10, the control section 10 acquires a curvature ρ (N+Δt) at the forward position X (N+Δt) and a curvature ρ (N−Δt) at the rearward position X (N−Δt).

As previously described, the rearward position X (N−Δt) is behind the forward position X (N+Δt) and the target position, and is in front of the current position of the own vehicle on the road.

The operation flow progresses to step S520.

In step S520, the control section 10 calculates a target yaw rate γ at the target position X (N). The target yaw rate γ can be expressed by the following equation (1) which uses the curvature ρ and a moving speed V of the own vehicle.

γ=ρV (1)

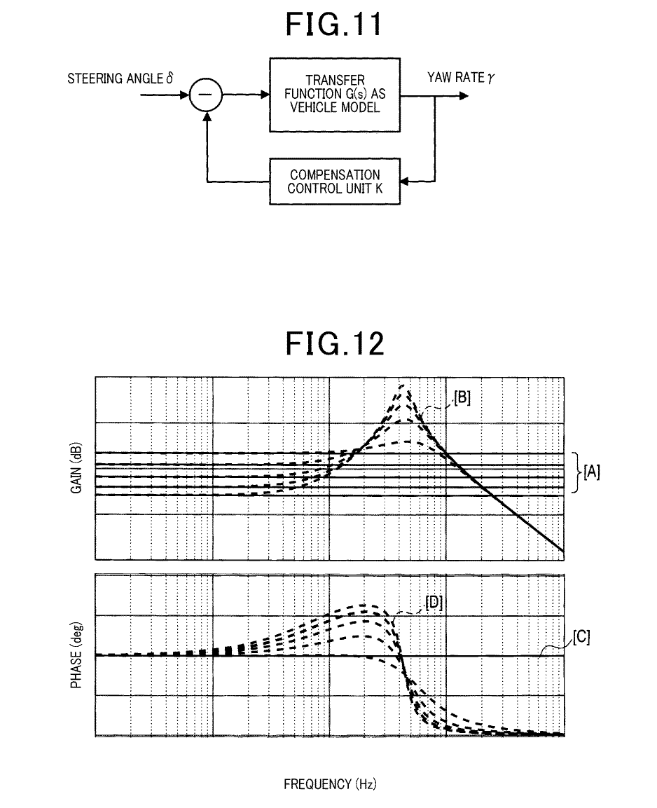

The operation flow progresses to step S530. In step S530, the control section 10 calculates the target steering angle for a compensation control unit K. FIG. 11 is a block diagram showing a transfer function of the control device 10 which has the compensation control unit K, and calculates the yaw rate γ on the basis of the steering angle δ. The compensation control unit K shown in FIG. 11 receives the yaw rate γ and generates and transmits the target steering angle δ.

That is, when G (s) represents the transfer function of the yaw response to the steering angle, the relationship between the steering angle δ and the target yaw rate γ can be expressed by the following equation (2) which uses the compensation control unit K.

$$γ = \frac{G ( s )}{1 + G ( s ) K} δ \qquad ( 2 )$$

When the yaw response in the steady state is G(0), the yaw response H(s) to the steering angle δ after the compensation control process can be expressed by the following equation (3).

$$H ( s ) = \frac{G ( s )}{1 + G ( s ) K} = G ( 0 ) \qquad ( 3 )$$

Accordingly, it is possible to express the characteristics of the compensation unit K by the following equation (4).

$$G ( s ) = ( 1 + G ( s ) K ) G ( 0 ) \\ G ( s ) K = \frac{G ( s )}{G ( 0 )} - 1 \\ K = ( \frac{G ( s )}{G ( 0 )} - 1 ) \frac{1}{G ( s )} = \frac{1}{G ( 0 )} - \frac{1}{G ( s )} \qquad ( 4 )$$

If the transfer function G(s) of the yaw response is a secondary transfer function, transfer function G(s) of the yaw response can be expressed by the following equation (5).

$$G ( s ) = \frac{as + b}{{cs}^{2} + ds + e} \qquad ( 5 )$$

The compensation control unit K can be expressed by the following equation (6).

$$K = - \frac{bcs + ( bd - ae )}{abs + {b}^{2}} s \qquad ( 6 )$$

FIG. 12 is a view showing Bode plots which represent frequency characteristics of the transfer function. As shown in FIG. 12, the use of the compensation control unit K shown in FIG. 11 can reduce the influence to the gain and the phase response to frequencies.

In more detail, as designated by the reference characters [B] and [D] shown in FIG. 12 which do not use the compensation control unit K, when the frequency varies, a degree of the gain and the phase delay varies. On the other hand, as designated by the reference characters [A] and [C] shown in FIG. 12 which use the compensation control unit K, even if the frequency varies, a degree of the gain and the phase delay do not almost vary.

It can be recognized that the compensation unit K contains a differential element and generates a delay. It is preferable for the control section 10 to execute a smoothing process so as to eliminate noise because the differential calculation contains noise.

In general, it is possible to use a backward differential method so as to execute the smoothing process. The backward differential method can be expressed by the following equation (7).

$$\dot{y} = \frac{y ( t ) - y ( t - Δ t )}{Δ t} \qquad ( 7 )$$

The backward differential method has a feature for executing the smoothing process on the basis of the sensor value only. However, this backward differential method increases a phase delay when increasing the minute time Δt (or the phase delay time Δt), and is easily influenced by noise when reducing the minute time Δt (or the phase delay time Δt). Accordingly, the control unit 10 according to the exemplary embodiment uses the central differential method expressed by the following equation (8).

$$\dot{ρ} = \frac{ρ ( t + Δ t ) - ρ ( t - Δ t )}{2 Δ t} \qquad ( 8 )$$

The differential value y in the equation (7) and the differential value ρ in the equation (8) previously described correspond to the value s in the equation (6).

As previously described, the structure of the drive assist system according to a modification of the exemplary embodiment as the steering control device central differential method uses the central differential method and executes the smoothing process on the basis of the information regarding the curvature ρ of the road on a future position of the own vehicle. This structure makes it possible to reduce the phase delay of the control parameters even if the control section 10 increases the minute time Δt (or the phase delay time Δt) and uses the increased minute time Δt.

As previously described, the control section 10 in the drive assist system according to the exemplary embodiment determines various control parameters such as the steering angle as the steering characteristics of the own vehicle at the target position X(N) on the basis of the curvature ρ (N+Δt) at the forward position X (N+Δt) and the curvature ρ (N−Δt) at the rearward position X (N−Δt), where this target position X(N) is located between the forward position and the rearward position on the road on which the own vehicle drives.

After this process, the control section 10 finishes the execution of the steering angle calculation process in step S140, and also finishes the assist control process shown in FIG. 4.

The drive assist system 1 as the steering control device according to the exemplary embodiment having the structure previously described has following excellent effects.

(1a) In the drive assist system 1 according to the exemplary embodiment having the improved structure previously described, the control section 10 acquires the forward road shape which represents a road shape at the forward position in front of the current position of the own vehicle on the road, on which the own vehicle drives.

The control section 10 further acquires the rearward road shape which represents a road shape at the rearward position which is behind the forward position.

In particular, the rearward position is behind the forward position and the target position, and is in front of the current position of the own vehicle on the road.

The control section 10 determines the steering characteristics of the own vehicle at the target position on the road on the basis of the acquired forward road shape and the acquired rearward road shape, where the target position is located between the forward position and the rearward position on the road. The control section 10 executes the steering control of the own vehicle according to the determined steering characteristics of the own vehicle.

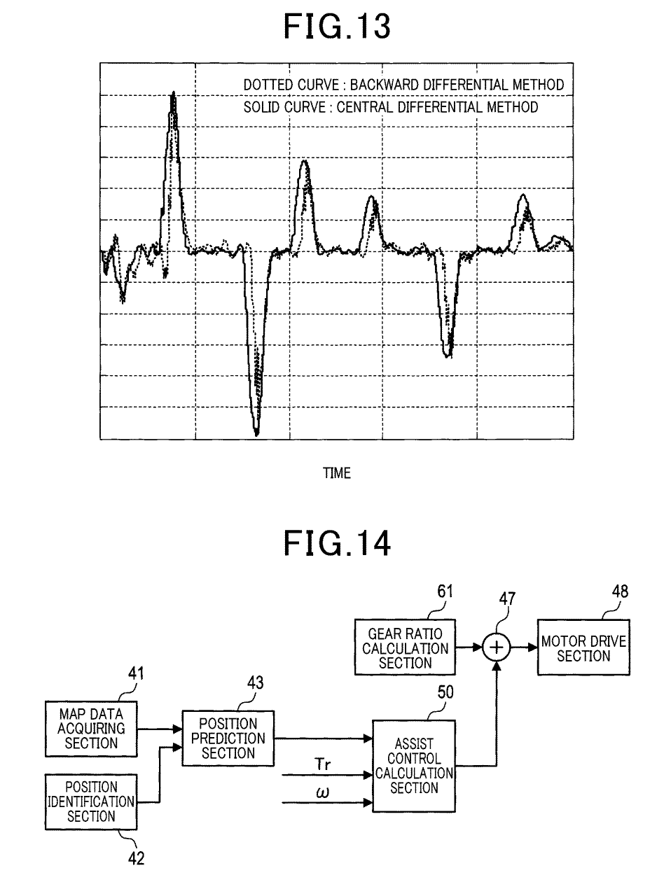

Because the drive assist system 1 according to the exemplary embodiment having the improved structure previously described determines the steering characteristics on the basis of the forward road shape on the road, it is possible to prevent and speedily suppress generation of a time delay during the execution of the steering control. In more detail, FIG. 13 shows comparison results in phase delay between the central differential method and the backward differential method.

FIG. 13 is a graph representing the comparison results in phase delay between the backward differential method and the central differential method. In FIG. 13, the horizontal axis indicates time, the vertical axis represents the control amount, the dotted curve represents the backward differential method, and the solid curve represents the central differential method.

As can be understood from FIG. 13, the central differential method, designated by the solid curve, has a reduced control delay which is smaller than the control delay generated in the backward differential method designated by the dotted curve.

(1b) In the drive assist system 1 according to the exemplary embodiment previously described, the control section 10 determines, as the steering characteristics, at least one of yaw response, roll response, and lateral G of the own vehicle. Accordingly, because the drive assist system 1 as the steering control device according to the exemplary embodiment can determine at least one of yaw response, roll response, and lateral G of the own vehicle so as to prevent generation of the time delay and phase delay when the driving assistance control follows the variation of the road shape, it is possible for the driver of the own vehicle to perform comfortable steering operation and to easily operate the steering wheel of the own vehicle.
(1c) In the drive assist system 1 having the structure previously described, the control section 10, the control section 10 judges whether the current state of the own vehicle is in the steering angle increase state or the steering angle return state of the steering wheel. The control section 10 adjusts the control parameters so that the resistance degree of the steering operation using the steering wheel in the steering angle increase state becomes smaller than that in the steering angle return state.

Because of reducing the resistance degree of the steering operation in the steering angle increase state rather than in the steering angle return state, the drive assist system 1 having the structure previously described increases the turn ability of the steering operation using the steering wheel during the steering angle increase state, and maintains the stable drivability of the own vehicle during the steering angle return state of the steering wheel.

(1d) In the drive assist system 1 according to the exemplary embodiment previously described, the control section 10 acquires the curvature of the road, as road shape information, on which the own vehicle drives. Accordingly, it is possible for the drive assist system 1 having the structure previously described to easily calculate and determine the steering characteristics at the target position on the road on the basis of the acquired curvature of the road.
(1e) In the drive assist system 1 according to the exemplary embodiment previously described, the control section 10 acquires, as the target position, a position on the road at which the own vehicle will pass at the predetermined future time, and acquires the forward road shape which represents a road shape at the forward position in front of the target position of the own vehicle on the road, and acquires the rearward road shape which represents a road shape at the rearward position on the road. The rearward position is behind the forward position and the target position, and is in front of the current position of the own vehicle on the road.

Accordingly, because the control section 10 in the drive assist system 1 having the structure previously described determines vehicle characteristics of the own vehicle on the basis of the acquired forward road shape and the acquired rearward road shape on the road which have been determined on the basis of the target position on the road through which the own vehicle will pass at a future time, it is possible for the driver of the own vehicle to operate the steering wheel and adjust the steering angle of the own vehicle with time to spare.

(1f) In the drive assist system 1 according to the exemplary embodiment previously described, the control section 10 acquires the forward road shape on the road, which is in front of the target position by the phase delay time caused in the differential calculation. Accordingly, it is possible for the control section 10 to compensate the phase delay time caused by the differential calculation.

Accordingly, because the control section 10 in the drive assist system 1 having the improved structure previously described uses and executes the central differential method so as to calculate the steering angle of the own vehicle, this makes it possible to speedily suppress the control delay of the steering angle of the own vehicle.

### Other Modifications

A description will now be given of various modifications of the drive assist system 1 as the steering control device according to the exemplary embodiment. It is acceptable for the drive assist system 1 as the steering control device to have the following various modifications.

(2a) FIG. 14 is a view showing functional blocks of a control section 10-1 having another structure of the control section 10 in the drive assist system according to a modification of the exemplary embodiment.

As shown in FIG. 14, it is acceptable for the control section 10-1 to have a gear ratio calculation section 61 instead of using the assist control calculation section 46 shown in FIG. 2. The gear ratio calculation section 61 calculates a gear ratio in a gear assembly which determines a change amount of a steering angle to an operation amount of a steering wheel in a known variable Gear ratio Steering (SVG) so as to generate and transmit a control amount corresponding to a target ratio of the gear ratio.

The assist control calculation section 50 multiplies the steering angle δ and a predetermined gain together, and transmits the multiplication result as a steering angle compensation control amount.

The motor drive section 48 changes the gear ratio so as to have the steering angle compensation control amount transmitted from the assist control calculation section 50, and drives the steering motor 31.

(2b) In the drive assist system 1 as the steering control device according to the exemplary embodiment previously described, the control section 10 determines the forward position X (N+Δt) and the rearward position X (N−Δt) which are not the current time, i.e. are future time at which the own vehicle will pass. However, the subject matter of the present invention is not limited by this.

It is sufficient for the control section 10 to determine at least the forward position X (N+Δt) so that the own vehicle will pass the forward position X (N+Δt) on the road at a future time. On the other hand, it is acceptable for the control section 10 to determine the rearward position X (N−Δt) so that the own vehicle is passing the rearward position X (N−Δt) at the current time, or has passed the rearward position X (N−Δt) at a past time.

(2c) It is acceptable to combine the plural functions of one section in the control section 10, 10-1 to plural components, or to divide one function of one section in the control section 10, 10-1 to plural components.

Further, it is also acceptable to combine the plural functions of the sections in the control section 10, 10-1 to a single component, or to form one function, which is obtained by plural components, by using a single component. It is also acceptable to add a part of the components forming the control section 10, 10-1 to another component or components.

(2d) It is possible to realize the drive assist system 1, or the control section 10, 10-1 previously described by using programs and/or a non-transitory computer readable storage medium for storing those programs for causing a central processing unit in a computer system to execute the functions previously described.

### (Correspondence)

The drive assist system 1 used in the exemplary embodiment previously described corresponds to the steering control device. The map data acquiring section 41 used in the exemplary embodiment previously described corresponds to the road shape information acquiring section. The parameter calculation section 51 used in the exemplary embodiment previously described corresponds to the state judgment section. A combination of the parameter calculation section 51 and the steering angle calculation section 52 used in the exemplary embodiment previously described corresponds to the characteristics determination section. The gain setting section 53 used in the exemplary embodiment previously described corresponds to the steering angle control section.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A steering control device executing steering control of an own vehicle, comprising a computer system including a central processing unit, the computer system being configured to provide:
a road shape information acquiring section which acquires a forward road shape which represents a road shape at a forward position in front of a current position of an own vehicle on a road, on which the own vehicle drives, and acquires a rearward road shape which represents a road shape at a rearward position on the road, the rearward position being behind the forward position and being in front of the current position of the own vehicle on the road;
a characteristics determination section which determines steering characteristics of the own vehicle at a target position on the road on the basis of the forward road shape and the rearward road shape acquired by the road shape information acquiring section, the target position being located between the forward position and the rearward position on the road; and
a steering angle control section which adjusts the steering angle of the own vehicle on the basis of the steering characteristics of the own vehicle determined by the characteristics determination section.

2. The steering control device executing steering control of the own vehicle according to claim 1, wherein the characteristics determination section determines, as the steering characteristics of the own vehicle, at least one of yaw response, roll response, and lateral G of the own vehicle.

3. The steering control device executing steering control of the own vehicle according to claim 1, the computer system which is configured to further comprises a state judgment section which detects whether the state of the own vehicle is in a steering angle increase state or a steering angle return state, wherein the steering angle increase state represents an increase state of turn of a steering wheel of the own vehicle, and the steering angle return state represents the steering angle of the steering wheel of the own vehicle is reduced, and
wherein the characteristics determination section determines the steering characteristics at an optional steering angle of the own vehicle so that a steering resistance in the steering angle increase state becomes smaller than a steering resistance in the steering angle return state.

4. The steering control device executing steering control of the own vehicle according to claim 1, wherein the road shape information acquiring section acquires a curvature of the road.

5. The steering control device executing steering control of the own vehicle according to claim 1, wherein
the road shape information acquiring section uses the target position through which the own vehicle will pass at a predetermined future time, and the road shape information acquiring section acquires the forward road shape which represents the road shape at the forward position in front of the target position on the road, and acquires the rearward road shape which represents the road shape at the rearward position on the road, the rearward position is behind the target position and is in front of the current position of the own vehicle on the road.

6. The steering control device executing steering control of the own vehicle according to claim 1, wherein
the road shape information acquiring section acquires, as the forward road shape, a road shape of a forward position which is forward by a phase delay amount generated by a differential calculation for the target position.

7. The steering control device executing steering control of the own vehicle according to claim 6, wherein
the characteristics determination section calculates a target steering angle at the target position on the road by using a central differential method using the forward road shape and the rearward road shape, and the steering angle control section adjusts the steering angle of the own vehicle to have the target steering angle at the target position on the road.

8. A method of executing steering control of an own vehicle, comprising steps of:
acquiring a forward road shape which represents a road shape at a forward position in front of a current position of an own vehicle on a road, on which the own vehicle drives, and acquiring a rearward road shape which represents a road shape at a rearward position on the road, the rearward position being behind the forward position and being in front of the current position of the own vehicle on the road;
determining steering characteristics of the own vehicle at a target position on the road on the basis of the forward road shape and the rearward road shape acquired by the road shape information acquiring section, the target position being located between the forward position and the rearward position on the road; and
adjusting the steering angle of the own vehicle on the basis of the steering characteristics of the own vehicle determined by the characteristics determination section.

9. The method of executing steering control of the own vehicle according to claim 8, wherein the step of determining the steering characteristics of the own vehicle determines at least one of yaw response, roll response, and lateral G of the own vehicle.

10. The method of executing steering control of the own vehicle according to claim 8, further comprising a step of detects whether the state of the own vehicle is in a steering angle increase state or a steering angle return state, wherein the steering angle increase state represents an increase state of turn of a steering wheel of the own vehicle, and the steering angle return state represents the steering angle of the steering wheel of the own vehicle is reduced, and
the step determines the steering characteristics at an optional steering angle of the own vehicle so that a steering resistance in the steering angle increase state becomes smaller than a steering resistance in the steering angle return state.

11. The method of executing steering control of the own vehicle according to claim 8, wherein the step of acquiring the road shape acquires a curvature of the road.

12. The method of executing steering control of the own vehicle according to claim 8, wherein the step of acquiring the road shape uses the target position through which the own vehicle will pass at a predetermined future time, acquires the forward road shape which represents the road shape at the forward position in front of the target position on the road, and acquires the rearward road shape which represents the road shape at the rearward position on the road, wherein the rearward position is behind the target position and is in front of the current position of the own vehicle on the road.

13. The method of executing steering control of the own vehicle according to claim 8, wherein the step of acquiring the road shape acquires, as the forward road shape, a road shape of a forward position which is forward by a phase delay amount generated by a differential calculation for the target position.

14. The method of executing steering control of the own vehicle according to claim 8, the step of determining the steering characteristics of the own vehicle calculates a target steering angle at the target position on the road by using a central differential method using the forward road shape and the rearward road shape, and
the step of adjusting the steering angle of the own vehicle adjusts the steering angle of the own vehicle to have the target steering angle at the target position on the road.
